(19) United States
(12) Patent Application Publication
(10) Pub. No.: US 2008/0210080 A1
(43) Pub. Date: Sep. 4, 2008

(54) Cheock 12 Dimension Music Code with Decoders

(76) Inventor: Cheock Frederick Hubert Sarimento, Jr., Metro Manila (PH)

Correspondence Address: Frederick Hubert S. Cheock, Jr., 4 Rosemary Lane,1600 Pasig city, Metro Manila, PH

(21) Appl. No.: 11/663,139

(22) PCT Filed: Dec. 5, 2005
(86) PCT No.: PCT/PH05/00024

§ 371 Date: Mar. 16, 2007

(30) Foreign Application Priority Data
Feb. 1, 2005 (PH) PCT PHO5 000006

(51) Int. Cl. G09B 15/02

(52) U.S. Cl. 84/471 R

(57) ABSTRACT

The device, “The Cheock 12 Dimension Music Code” (Music Code), and the method of using it, “The Cheock Decoder”. The Music Code as embodied in, and is composed of, the Numbers Chart, Notes Chart, and Chords Chart (FIGS. 1 to 3). The Numbers Chart is composed of the numbers 1 to 12 arranged in a horizontal and vertical manner, starting at the bottom row. The Notes Chart is similarly arranged but using the 12 musical notes in substitution of the numbers, each row representing a different musical key. The Chords Chart, based on the Numbers Chart, uses 12 specially grouped musical chords. The Cheock Decoder consists if 32 components (“Components”, FIGS. 4 to 35), each Component is a horizontal bar with one or two sets of 12 fixed positions numbered 1 to 12 and with a distinct pattern of transparent circular openings. When different components are applied over the Music Code Chords Chart (Components 1 and 2) and the Music Code Notes Charts (Components 3 to 32), the users can, depending on the Component utilized, effortlessly identify Member Chord Families, Commonly Used Scales, Basic Chord musical notes/chords, arrangements and compositions, into different musical keys, and allows the musician to easily move from Key to Key by simply identifying common notes/chords in the current Key being played and in the Key which the musician intends to move to, while maintaining or developing musical melodies.

### TECHNICAL FIELD

The Invention pertains to the field of musical guides and charts, particularly relating to practical musical application in playing and converting notes and chords in various musical keys, music instruction and ease of practical musical application.

### BACKGROUND ART

On 1 Feb. 2005, an application was filed by herein inventor under the Patent Cooperation Treaty (PCT) with the Intellectual Property Office of the Philippines, for the invention entitled “THE CHEOCK 12 DIMENSION MUSIC CODE” (the “Music Code”). The same was issued International PCT Application No. PCT/PH2005/000006. The Music Code is composed of three (3) charts—the numbers chart, the notes chart and the chords chart (the “Music Code Charts”).

Presently, the conversion of musical arrangements or compositions to any particular key, using existing charts and methods, is extremely complicated and require substantial effort and time. The Music Code, the first of its kind, addresses the difficult and often complex problem or task of identifying and playing notes and chords in the various musical keys.

The inventor of the “Music Code” and the “Cheock 12 Dimension Music Code with Decoders” are one and the same (the “Inventor”).

While the “Music Code” is a fully functional and working invention, the use thereof may take more time and effort than the end-users may be willing to invest, thereby potentially limiting the widespread benefits that the “Music Code” is capable of imparting.

### DISCLOSURE OF THE INVENTION

The “Cheock 12 Dimension Music Code with Decoders” (the “Invention”), is a combination of the Music Code (with PCT Application No. PCT/PH2005/000006) and Cheock Decoder.

The Cheock Decoder is used to address the above relative difficulty in interpreting and utilizing the Music Code, and greatly enhances the ease of use of the Music Code Charts. The Cheock Decoder demonstrates the method of using the Music Code. The Invention is composed of the three (3) Music Code charts (the numbers chart, the notes chart and the chords chart, hereinafter referred to the “Music Code Charts”), and the Cheock Decoder comprising of thirty two (32) specially designed visual components (the “Components”). Each Component of the Cheock Decoder consists of a distinct pattern of transparent circular gaps or openings.

When the different components of the Cheock Decoder applied over the Music Code Chords Chart (Components 1 and 2 of the Cheock Decoder) and the Music Code Notes Charts (Components 3 to 32 of the Cheock Decoder), the users thereof can, depending on which Component is utilized, effortlessly discern and identify Member Chord Families, Commonly Used Scales, Basic Chord Qualities, Expanded Chord Qualities, and Altered Chord Qualities.

### Music Code

As described in its International PCT Application No. PCT/PH2005/000006, the Music Code is a novel and unique Musical Code which enables musicians to easily identify and play notes and chords in the various musical keys, allowing them to shift from key to key without difficulty. Moreover, melody will not suffer as the transitions are made through common notes within the transposed keys as revealed in the Music Code. Translation or conversion of entire musical compositions or arrangements is likewise made easier by the use of the Music Code.

The essence of the Music Code is governed by the number 12. The inventor formulated his own concept and theory of music around the number 12 and embodied the same in the Music Code. The number 12 identifies and correlates the inventor's Chromatic 12 keys, 12 musical notes, and 12 members of the chord family (to be hereinafter referred to as “Musical Elements”). Furthermore, these Musical Elements have been arranged within the Music Code in a unique and absolute order and sequence, exposing relationships and connections with each other, giving a graphic and visual presentation on the otherwise invisible patterns and relationships in music.

The Music Code is, therefore, the quintessence of the 12 dimensions of music, as conceptualized by the inventor and described in the immediately preceding paragraph.

The Music Code serves as a musical outline to simplify musical movements from key to key, chord to chord, note to note, and melody to melody. The Music Code likewise reveals the patterns of compositions in music, whether it be classical, jazz, blues, rock, or contemporary music. Furthermore, the Music Code is universally applicable to almost all types of instruments, including guitar, keyboards, piano, and xylophone.

With the Music Code, musicians can easily identify sequential modulation patterns such that various compositions, including classical compositions of Beethoven and Mozart, can be easily identified and transposed in different keys using the same modulation patterns.

Moreover, the Music Code opens novel musical pathways that have never been explored before, including musical compositions composed exclusively of tension chords or compositions with multiple key signatures.

In addition, the Music Code unveils the Chord Derivation and Structure of every Chord Quality. It reveals musical pathways for melodies that have been composed and those that are yet to be composed. It also provides novel methods to learn music resulting in ease of memorization and speed of practical musical application. Finally, the Music Code is based on numerical codes which can be adopted to provide significant music software applications.

The Music Code is embodied in, and composed of, three (3) charts (the numbers chart, the notes chart, and the chords chart). The notes chart and chords chart are direct musical derivations of the numbers chart.

### Numbers Chart

The numbers chart is composed in a manner such that the numbers 1 to 12 are sequentially arranged in a horizontal manner, starting on the bottom row. The first row of numbers 1 to 12 is positioned at the bottom row and may be repeated horizontally in as many sets of 12 as desired. The second row of numbers 1 to 12 is arranged above the first row, with one step to the right, such that number 1 in the second row is located right above number 2 of the first row, number 2 in the second row is located right above number 3 of the first row and so on.

To complete a single usable numbers chart, the numbers 1 to 12 are made to repeat continuously to fill a tile that contains a complete set of 12 numbers, with number 1 of the next top row always above number 2 of the row right below it, number 2 of the top row located above number 3 of the bottom row, and so forth. This tile may then be repeated horizontally and vertically to produce a chart representing several sets of numbers from 1 to 12.

The numbers chart is the blueprint of the Music Code and can be used to derive both the Notes Chart and Chords Chart.

### Notes Chart

The 12 Numerals in the Numbers Chart may be used to represent the Chromatic 12 Musical Notes, in each of the 12 Keys.

Using the Numbers Chart as a blueprint, the series of number 1's starting from the lower-left hand corner of the chart and moving diagonally upwards each represent the 12 different musical Keys from the key of C to the key of B. Thus, each of the 12 Keys are identified by the 12 number 1's.

Each Key is, in turn, composed of the Chromatic 12 Notes.

Correspondingly, the first note of each of the 12 Keys, as depicted in the Notes Chart, are likewise represented by the number 1's in the Numbers Chart. Hence, the first note in the Key of C, which is Note C, is in the number 1 location on the Numbers Chart located at the lower-left hand corner of the chart. Moving a step upwards in a diagonal manner, the first note in the Key of C#, which is Note C#, is also in the number 1 location on the Numbers Chart; and so on. In other words, each of the first notes of the 12 Keys are also identified by the 12 number 1's.

Corollary to the foregoing, the numbers 1 to 12 in each of the Keys (each row of numbers 1 to 12) represent each of the Chromatic 12 Notes as may be played in each Key. Hence, in the Key of C (the lowest row), the numbers 1 to. 12 represent the Chromatic Notes C to B. In the Key of C# (one diagonal row above the Key of C), the numbers 1 to 12 represent the Chromatic Notes C# to C. In Key of B, the 12^{th} row of numbers 1 to 12 from the bottom, the numbers 1 to 12 represent the Chromatic Notes B to A#.

The relationship of the Chromatic 12 Notes and 12 Keys as derived from the Numbers Chart are illustrated in the Notes Chart. As a result, the numbers 1 to 12 found in the Numbers Chart are replaced with symbols for the corresponding Chromatic Notes and Keys.

As in the Numbers Chart, the Notes and Keys are made to repeat its pattern in a continuous sequence to fill a tile that contains a complete set of Notes and Keys. This tile may then be repeated horizontally and vertically to produce the Notes Chart representing a systemic visual repetition of several sets of Notes and Keys.

The Notes Chart addresses and simplifies the problem or task of converting and playing musical notes, arrangement and compositions, into the different musical keys without the difficulty accompanying existing methods for doing so. The Notes Chart also allows the musician to easily move from Key to Key by simply identifying common Notes in the current Key being played and in the Key which the musician intends to move to, while maintaining or developing musical melodies.

### Chords Chart

In devising the Chords Chart, additional Chords were identified and utilized by the Inventor to increase the generally accepted 7 Members of the Chord Family to 12 Members of the Chord Family.

To increase the use of the last chord (7^{th}) in the musical compositions, the Inventor standardized the same to be 5 M/12 when used within the Chord Family.

The accepted 7 Members of the Chord Family are: 1 M, 2 m, 3 m, 4 M, 5 M, 6 m and 7, with the “1m” representing minor chords and the “M”, major chords.

On the other hand, the Inventor identified and utilized 5 additional Members of the Chord Family which resulted in the following 12 Members: 1M, 6M/2, 2m, 7M/4, 3m, 4M, 2M/7, 5M, 3M/9, 6m, 6#M, 7=5M/12. Slash Chords represent inversions from Root position, the numbers below the slash represent the notes from the key of the applicable Chord Family, as reflected in the Notes Chart.

Within the Chord Family, the 5 additional Members are called “Super Tension Chords” by the Inventor.

With the Chord Family expanded to 12 members by the Inventor, the numbers 1 to 12 in the Numbers Chart shall now be used to represent the 12 Members of the Chord Family, in each of the 12 Keys.

Again, using the Numbers Chart as a blueprint, and starting on the lower left corner of the chart, the series of number 1's moving diagonally upwards each represents the 12 Keys from the Key of C to Key of B. Thus, the 12 Keys are represented by the 12 number 1's in the Numbers Chart, starting from the lower left corner moving diagonally up the chart.

Each Key is, in turn, composed of the 12 Members of the Chord Family.

Similar to the Notes Chart, the first Chord Member of each Key is also represented by the number 1. Hence, the first Chord Member (Chord C) in the Key of C is represented by the number 1 located in the lower left corner of the Numbers Chart. The first Chord Member (Chord C#) in the Key of C4 is also represented by the number 1 located diagonally above the first-number 1; and so on. Thus, each of the first Chord Members in each of the Keys are also represented by the 12 number 1's.

On the other lend, the numbers 1 to 12 in each horizontal row of each Key, represents the 12 Members of the Chord Family as may be played in each Key. To illustrate, the 12 Members of the Chord Family in Key of C is represented by the numbers 1 to 12 in the lowest row in the Numbers Chart starting from Chord C (number 1) to Chord G/D (number 12). If a musician washes to use the Chords in the Key of F, instead of the Key of C, then the Chords Chart will reveal that the Key of F begins in the 6^{th} number 1 position counting from the lower left hand corner of the Chart, and the Chords in the Key of F would be found in the same row, with Chord F (number 1) as the first chord, followed by Chords D/G^{b}, Gₘ, E/A^{b}; and so on until Chord C/E (number 12).

The relationship of the 12 Members of the Chord Family and 12 Keys as derived from the Numbers Chart are illustrated in the Chords Chart. As a result, the numbers 1 to 12 found in the Numbers Chart are replaced with symbols for the corresponding 12 Members of the Chords Family.

As in the Numbers Chart, the Chords and Keys are made to repeat its pattern in a continuous sequence to fill a tile that contains a complete set of Chords and Keys. This tile may then be repeated horizontally and vertically to produce the Chords Chart representing a systemic visual repetition of several sets of Chords and Keys.

The Chords Chart addresses and simplifies the problem or task of converting and playing musical chords, arrangement and compositions, into the different musical keys without the difficulty accompanying existing methods for doing so. The Chords Chart also allows the musician to easily move from Key to Key by simply identifying common Chords in current Key being played and in the Key which the musician intends to move to, while maintaining or developing musical melodies.

### Cheock Decoder

On the other hand, each Component of the Cheock Decoder which may be embodied in a transparent device such as acetate and positioned over the Music Code Chords and Notes Charts, to identify the following musical elements:

| | | Applicable |
|---|---|---|
| | | Music Code |
| Component | Musical Element | Chart |
| Component 1 | 7 Major Chord Family Members in all 12 Keys | Chords Chart |
| Component 2 | 7 Minor Chord Family Members in all 12 Keys | Chords Chart |
| Component 3 | Major Scales and the 7 Modes | Notes Chart |
| Component 4 | Relative Minor Scales and the 7 Modes | Notes Chart |
| Component 5 | Harmonic Minor Scales and the 7 Modes | Notes Chart |
| Component 6 | Melodic Minor Scales and the 7 Modes | Notes Chart |
| Component 7 | Basic Chord Quality of 12 Major Chords in their Root Position | Notes Chart |
| | and Inversions | |
| Component 8 | Basic Chord Quality of 12 Minor Chords in their Root Position | Notes Chart |
| | and Inversions | |
| Component 9 | Basic Chord Quality of 12 Diminished Chords in their Root | Notes Chart |
| | Position and Inversions | |
| Component 10 | Basic Chord Quality of 12 Augmented Chords in their Root | Notes Chart |
| | Position and Inversions | |
| Component 11 | Basic Chord Quality of 12 Major 6^{th} Chords in their Root | Notes Chart |
| | Position and Inversions | |
| Component 12 | Basic Chord Quality of 12 Minor 6^{th} Chords in their Root | Notes Chart |
| | Position and Inversions | |
| Component 13 | Basic Chord Quality of 12 Major 7^{th} Chords in their Root | Notes Chart |
| | Position and Inversions | |
| Component 14 | Basic Chord Quality of 12 Minor 7^{th} Chords in their Root | Notes Chart |
| | Position and Inversions | |
| Component 15 | Basic Chord Quality of 12 7^{th} Chords in their Root Position and | Notes Chart |
| | Inversions | |
| Component 16 | Basic Chord Quality of 12 Diminished 7^{th} Chords in their Root | Notes Chart |
| | Position and Inversions | |
| Component 17 | Basic Chord Quality of 12 7^{th} Suspended 4^{th} Chords in their | Notes Chart |
| | Root Position and Inversions | |
| Component 18 | Basic Chord Quality of 12 7^{th} Sharp 5 Chords in their Root | Notes Chart |
| | Position and Inversions | |
| Component 19 | Expanded Chord Quality of 12 Major 9^{th} Chords in their Root | Notes Chart |
| | Position | |
| Component 20 | Expanded Chord Quality of 12 Minor 9^{th} Chords in their Root | Notes Chart |
| | Position | |
| Component 21 | Expanded Chord Quality of 12 9^{th} Chords in their Root Position | Notes Chart |
| Component 22 | Expanded Chord Quality of 12 Minor 11^{th} Chords in their Root | Notes Chart |
| | Position | |
| Component 23 | Expanded Chord Quality of 12 11^{th} Chords in their Root | Notes Chart |
| | Position | |
| Component 24 | Expanded Chord Quality of 12 13^{th} Chords in their Root | Notes Chart |
| | Position | |
| Component 25 | Altered Chord Quality of 12 7^{th} Flat 5 Chords in their Root | Notes Chart |
| | Position | |
| Component 26 | Altered Chord Quality of 12 9^{th} Flat 5 Chords in their Root | Notes Chart |
| | Position | |
| Component 27 | Altered Chord Quality of 12 9^{th} Sharp 5 Chords in their Root | Notes Chart |
| | Position | |
| Component 28 | Altered Chord Quality of 12 7^{th} Flat 9 Chords in their Root | Notes Chart |
| | Position | |
| Component 29 | Altered Chord Quality of 12 7^{th} Sharp 9 Chords in their Root | Notes Chart |
| | Position | |
| Component 30 | Altered Chord Quality of 12 9^{th} Sharp 11 Chords in their Root | Notes Chart |
| | Position | |
| Component 31 | Altered Chord Quality of 12 13^{th} Flat 9 Chords in their Root | Notes Chart |
| | Position | |
| Component 32 | Altered Chord Quality of 12 13^{th} Sharp 11 Chords in their Root | Notes Chart |
| | Position | |

Each Component is described in detail below:

### Component 1 and 2

Component 1 and 2 are composed of a horizontal bar containing twelve (12) fixed positions with seven (7) transparent circular gaps or openings in the following positions:

| | |
|---|---|
| Component 1 | 1, 3, 5, 6, 8, 10 and 12 |
| Component 2 | 1, 3, 4, 6, 8, 9, and 11 |

Each gap is correspondingly identified with the proper ordinals (1^{st} to 7^{th}) and numerals, which are indicated directly below said gaps. The horizontal bar positions that do not contain gaps are appropriately labeled “SKIP” below said positions.

By aligning the left-most gap over the any of the twelve (12) key chords of any chord family, as mapped in the Music Code Chord Chart, Component 1 and 2 will identify (a) the 7 Major Chord Family Members and the 7 Minor Chord Family Members, respectively, in all twelve (12) keys, (b) their sequential order within the Chord Family, and (c) the numerical code that uncovers them.

### Component 3 to 6

Component 3 and 4 are composed of a continuous horizontal bar containing two (2) sets of twelve (12) fixed positions. The positions are numbered one (1) to twelve (12) for the first set of 12 positions; and another series of numbers from one (1) to twelve (12) for the second set of 12 positions (higher octave). The horizontal bars contain seven (7) transparent circular gaps or openings in the following positions:

| | |
|---|---|
| Component 3 | 1, 3, 5, 6, 8, 10 and 12 |
| Component 4 | 1, 3, 4, 6, 8, 9, and 11 |
| Component 5 | 1, 3, 5, 6, 9, 10 and 12 |
| Component 6 | 1, 3, 5, 7, 9, 10 and 12 |

The gaps are identified with the proper ordinals (1^{st} to 7^{th}) and the corresponding numbers of its respective positions. To guide the user, the numerals for the second get of gaps are underlined, to indicate the higher octave. The horizontal bar positions that do not contain gaps are appropriately labeled “SKIP” below said positions.

By aligning the left-most gap over the key note of the musical scale to be uncovered in the Music Code, Component 3 to 6 will identify (a) the Major Scales, Relative Minor Scales, Harmonic Minor Scales, and Melodic Minor Scales, respectively, in all twelve (12) keys, (b) the sequential order of the Notes within the Scale, and (c) the numerical code that uncovers them.

In addition, the musical modes (pattern of intervals between each note in an octave) for each of the musical scales (major, relative minor, harmonic minor, and melodic minor scales) may be identified using Component 3 to 6 in conjunction with the Music Code Notes Chart. By using said Components, each of the modes in the applicable scale may be identified by the series of notes appearing in the gaps located in the positions as listed in the table below. Line indicators are also used in the Components to identify the gaps applicable to the different modes.

| | | | Positions in | Positions in |
|---|---|---|---|---|
| | Positions in | | Component 5 | Component 6 |
| | Component 3 | Positions in Component 4 | Harmonic Minor | Melodic Minor |
| | Major Scale | Relative Minor Scale | Scale | Scale |
| Mode 1 | 1, 3, 5, 6, 8, 10, 12, 1 | 1, 3, 4, 6, 8, 9, 11, 1 | 1, 3, 5, 6, 9, 10, 12, 1 | 1, 3, 5, 7, 9, 10, 12, 1 |
| Mode 2 | 3, 5, 6, 8, 10, 12, 1, 3 | 3, 4, 6, 8, 9, 11, 1, 3 | 3, 5, 6, 9, 10, 12, 1, 3 | 3, 5, 7, 9, 10, 12, 1, 3 |
| Mode 3 | 5, 6, 8, 10, 12, 1, 3, 5 | 4, 6, 8, 9, 11, 1, 3, 4 | 5, 6, 9, 10, 12, 1, 3, 5 | 5, 7, 9, 10, 12, 1, 3, 5 |
| Mode 4 | 6, 8, 10, 12, 1, 3, 5, 6 | 6, 8, 9, 11, 1, 3, 4, 6 | 6, 9, 10, 12, 1, 3, 5, 6 | 7, 9, 10, 12, 1, 3, 5, 7 |
| Mode 5 | 8, 10, 12, 1, 3, 5, 6, 8 | 8, 9, 11, 1, 3, 4, 6, 8 | 9, 10, 12, 1, 3, 5, 6, 9 | 9, 10, 12, 1, 3, 5, 7, 9 |
| Mode 6 | 10, 12, 1, 3, 5, 6, 8, 10 | 9, 11, 1, 3, 4, 6, 8, 9 | 10, 12, 1, 3, 5, 6, 9, 10 | 10, 12, 1, 3, 5, 7, 9, 10 |
| Mode 7 | 12, 1, 3, 5, 6, 8, 10, 12 | 11, 1, 3, 4, 6, 8, 9, 11 | 12, 1, 3, 5, 6, 9, 10, 12 | 12, 1, 3, 5, 7, 9, 10, 12 |

### Component 7 to 32

Component 7 to 32 are used to identify the twenty-six (26) different musical chords in their root positions and inversions, as appearing the Music Code Notes Chart (see table on pages 11-12 hereof).

The Components are composed of a continuous horizontal bar containing two (2) sets of twelve (12) fixed position. The positions are numbered one (1) to twelve (12) for the first set of 12 positions; and another series of numbers from one (1) to twelve (12) for the second set of 12 positions (higher octave). The horizontal bar of each component contains between five (5) to seven (7) transparent circular gaps or openings in the following positions:

| | |
|---|---|
| Component 7 | 1, 5, 8, 1, 5 |
| Component 8 | 1, 4, 8, 1, 4 |
| Component 9 | 1, 4, 7, 1, 4 |
| Component 10 | 1, 5, 9, 1, 5 |
| Component 11 | 1, 5, 8, 10, 1, 5, 8 |
| Component 12 | 1, 4, 8, 10, 1, 4, 8 |
| Component 13 | 1, 5, 8, 12, 1, 5, 8 |
| Component 14 | 1, 4, 8, 11, 1, 4, 8 |
| Component 15 | 1, 5, 8, 11, 1, 5, 8 |
| Component 16 | 1, 4, 7, 10, 1, 4, 7 |
| Component 17 | 1, 6, 8, 11, 1, 6, 8 |
| Component 18 | 1, 5, 9, 11, 1, 5, 9 |
| Component 19 | 1, 5, 8, 12, 3 |
| Component 20 | 1, 4, 8, 11, 3 |
| Component 21 | 1, 5, 8, 11, 3 |
| Component 22 | 1, 4, 8, 11, 3, 6 |
| Component 23 | 1, 8, 11, 3, 6 |
| Component 24 | 1, 5, 8, 11, 3, 6, 10 |
| Component 25 | 1, 5, 7, 11 |
| Component 26 | 1, 5, 7, 11, 3 |
| Component 27 | 1, 5, 9, 11, 3 |
| Component 28 | 1, 5, 8, 11, 2 |
| Component 29 | 1, 5, 8, 11, 4 |
| Component 30 | 1, 5, 8, 11, 3, 7 |
| Component 31 | 1, 5, 8, 11, 2, 6, 10 |
| Component 32 | 1, 5, 8, 11, 3, 7, 10 |

The gaps are identified with the corresponding numbers of its respective positions. To guide the user, the numerals for the second set of gaps are underlined, to indicate the higher octave.

By aligning the left-most gap over the root note of the Chord Quality, as mapped in the Music Code Notes Chart, Component 7 to 32 will identify (a) the twelve (12) various chords (as may be applicable for each Component; see table below) in their Root Position, 1^{st} Inversion, 2^{nd} Inversion, and (b) the numerical code that uncovers them.

The various chords in their Root Positions and Inversions are identified by the series of notes appearing in the gaps located in the positions as listed in the table below. Line indicators are also used in the Components to identify the gaps applicable to the root position and various inversions.

| | | Root | 1^{st} | 2^{nd} | 3^{rd} |
|---|---|---|---|---|---|
| Components | Chords | Position | Inversion | Inversion | Inversion |
| Component 7 | Major Chords | 1, 5, 8 | 5, 8, 1 | 8, 1, 5 | — |
| Component 8 | Minor Chords | 1, 4, 8 | 4, 8, 1 | 8, 1, 4 | — |
| Component 9 | Diminished Chords | 1, 4, 7 | 4, 7, 1 | 7, 1, 4 | — |
| Component 10 | Augmented Chords | 1, 5, 9 | 5, 9, 1 | 9, 1, 5 | — |
| Component 11 | Major 6^{th} Chords | 1, 5, 8, 10 | 5, 8, 10, 1 | 8, 10, 1, 5 | 10, 1, 5, 8 |
| Component 12 | Minor 6^{th} Chords | 1, 4, 8, 10 | 4, 8, 10, 1 | 8, 10, 1, 4 | 10, 1, 4, 8 |
| Component 13 | Major 7^{th} Chords | 1, 5, 8, 12 | 5, 8, 12, 1 | 8, 12, 1, 5 | 12, 1, 5, 8 |
| Component 14 | Minor 7^{th} Chords | 1, 4, 8, 11 | 4, 8, 11, 1 | 8, 11, 1, 4 | 11, 1, 4, 8 |
| Component 15 | 7^{th} Chords | 1, 5, 8, 11 | 5, 8, 11, 1 | 8, 11, 1, 5 | 11, 1, 5, 8 |
| Component 16 | Diminished 7^{th} Chords | 1, 4, 7, 10 | 4, 7, 10, 1 | 7, 10, 1, 4 | 10, 1, 4, 7 |
| Component 17 | 7^{th} Suspended 4^{th} | 1, 6, 8, 11 | 6, 8, 11, 1 | 8, 11, 1, 6 | 11, 1, 6, 8 |
| | Chords | | | | |
| Component 18 | 7^{th} Sharp 5 Chords | 1, 5, 9, 11 | 5, 9, 11, 1 | 9, 11, 1, 5 | 11, 1, 5, 9 |
| Component 19 | Major 9^{th} Chords in | 1, 5, 8, 12, 3 | — | — | — |
| | their Root Position | | | | |
| Component 20 | Minor 9^{th} Chords in | 1, 4, 8, 11, 3 | — | — | — |
| | their Root Position | | | | |
| Component 21 | 9^{th} Chords in their Root | 1, 5, 8, 11, 3 | — | — | — |
| | Position | | | | |
| Component 22 | Minor 11^{th} Chords in | 1, 4, 8, 11, | — | — | — |
| | their Root Position | 3, 6 | | | |
| Component 23 | 11^{th} Chords in their | 1, 8, 11, 3, 6 | — | — | — |
| | Root Position | | | | |
| Component 24 | 13^{th} Chords in their | 1, 5, 8, 11, | — | — | — |
| | Root Position | 3, 6, 10 | | | |
| Component 25 | 7^{th} Flat 5 Chords in | 1, 5, 7, 11 | — | — | — |
| | their Root Position | | | | |
| Component 26 | 9^{th} Flat 5 Chords in | 1, 5, 7, 11, 3 | — | — | — |
| | their Root Position | | | | |
| Component 27 | 9^{th} Sharp 5 Chords in | 1, 5, 9, 11, 3 | — | — | — |
| | their Root Position | | | | |
| Component 28 | 7^{th} Flat 9 Chords in | 1, 5, 8, 11, 2 | — | — | — |
| | their Root Position | | | | |
| Component 29 | 7^{th} Sharp 9 Chords in | 1, 5, 8, 11, 4 | — | — | — |
| | their Root Position | | | | |
| Component 30 | 9^{th} Sharp 11 Chords in | 1, 5, 8, 11, | — | — | — |
| | their Root Position | 3, 7 | | | |
| Component 31 | 13^{th} Flat 9 Chords in | 1, 5, 8, 11, | — | — | — |
| | their Root Position | 2, 6, 10 | | | |
| Component 32 | 13^{th} Sharp 11 Chords in | 1, 5, 8, 11, | — | — | — |
| | their Root Position | 3, 7, 10 | | | |

### BRIEF DESCRIPTION OF THE DRAWINGS

Music Code The following figures illustrate the Music Code Numbers, Notes and Chords Charts:

FIG. 1 illustrates the Numbers Chart.

FIG. 2 illustrates the Notes Chart, a systemic visual repetition of several sets of the Chromatic 12 Musical Notes in each of the 12 Keys.

FIG. 3 illustrates the Chords Chart, a visual representation of the 12 Members of the Chord Family (i.e. the generally accepted 7 Members of the Chord Family and 5 additional members called the “Super Tension Chords” within the Chord Family) in each of the 12 Keys.

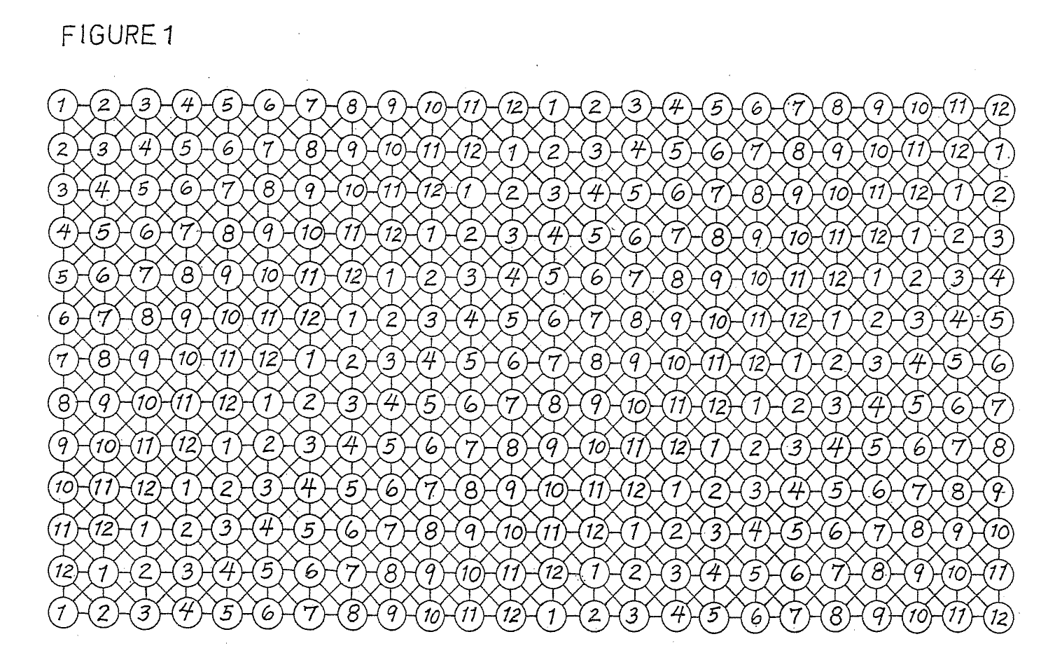

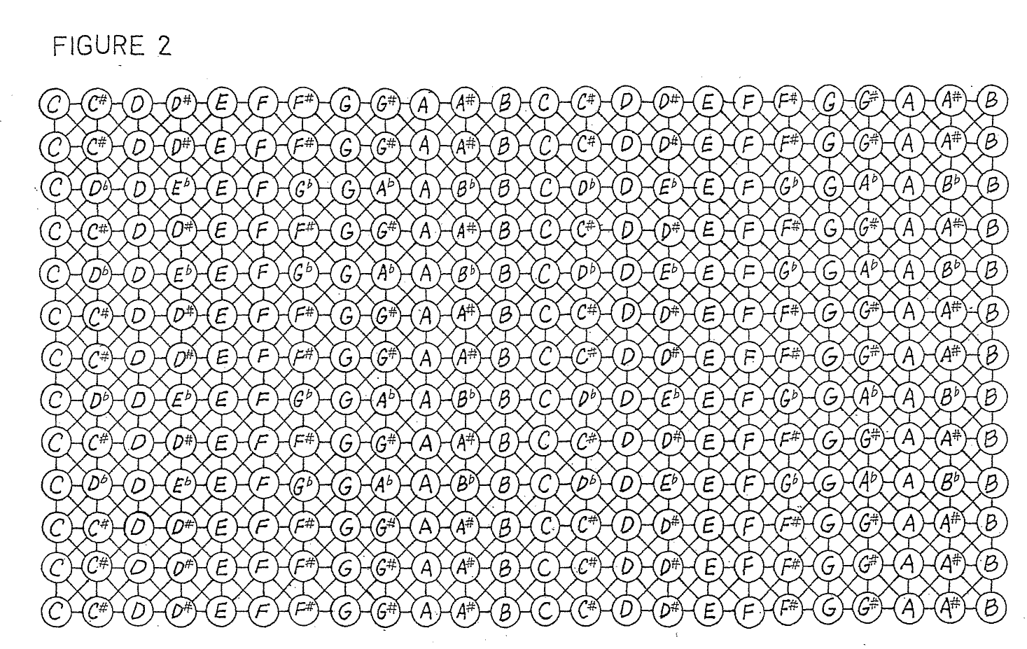

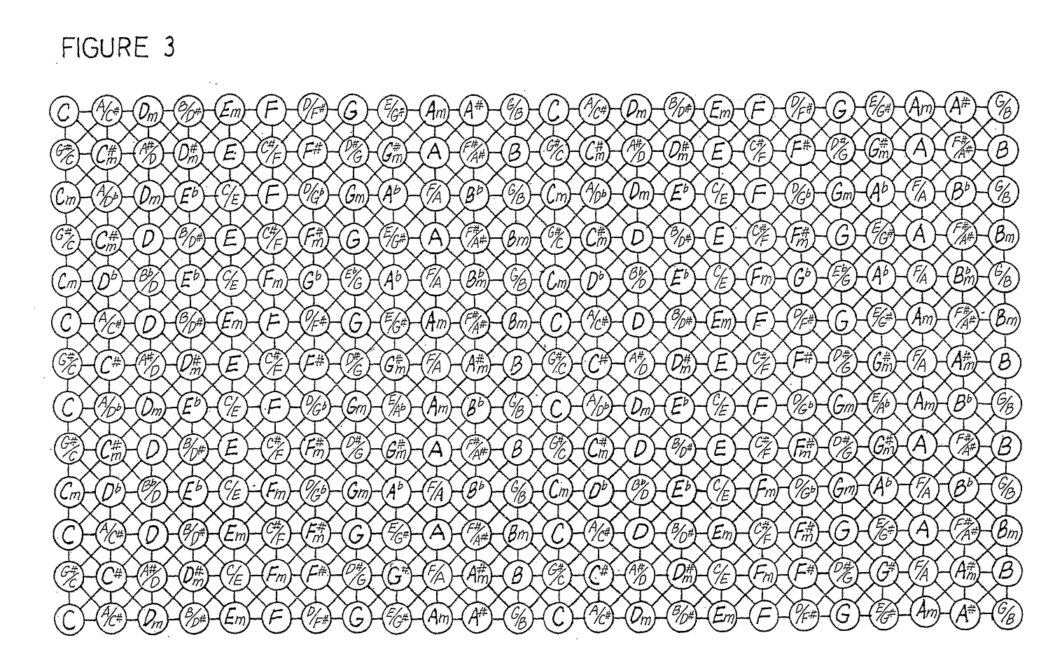

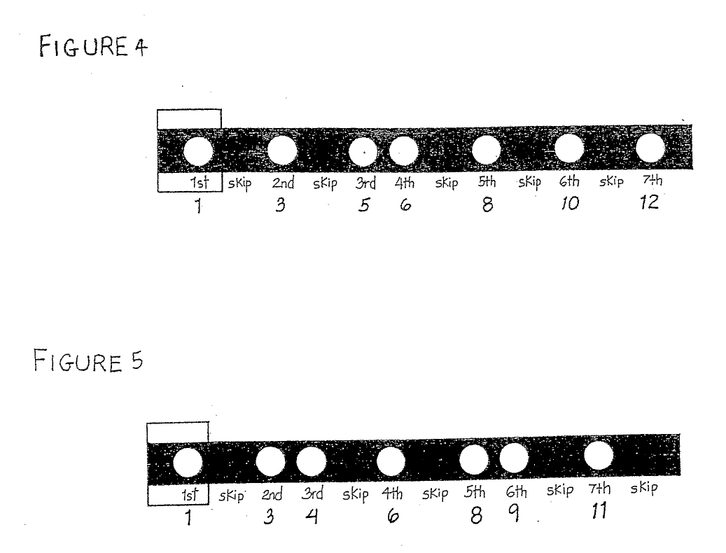

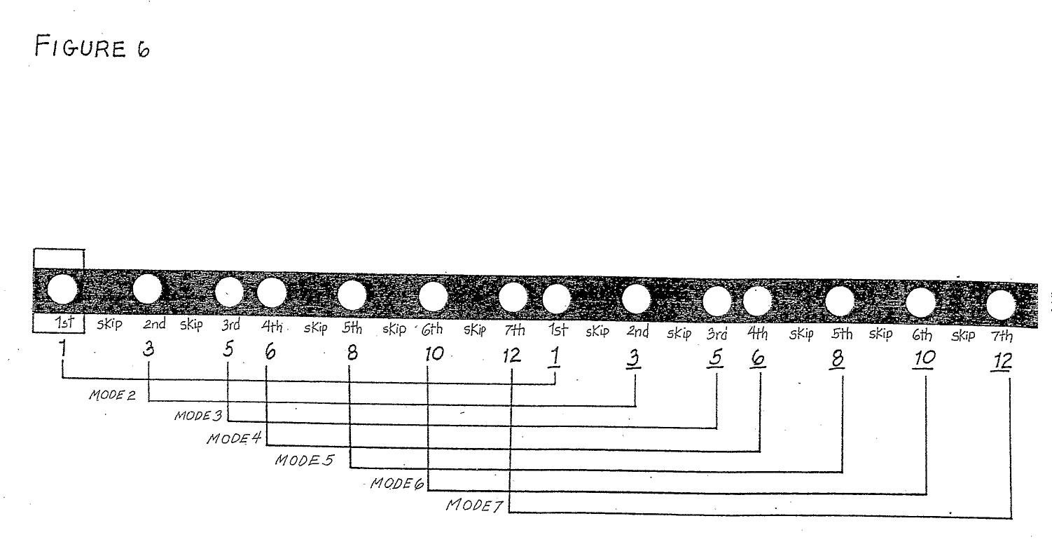

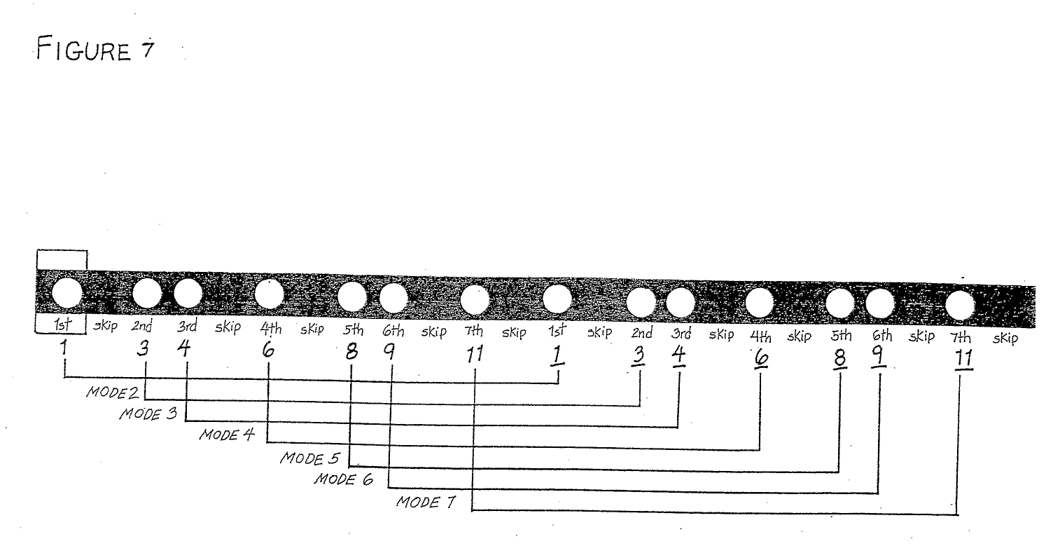

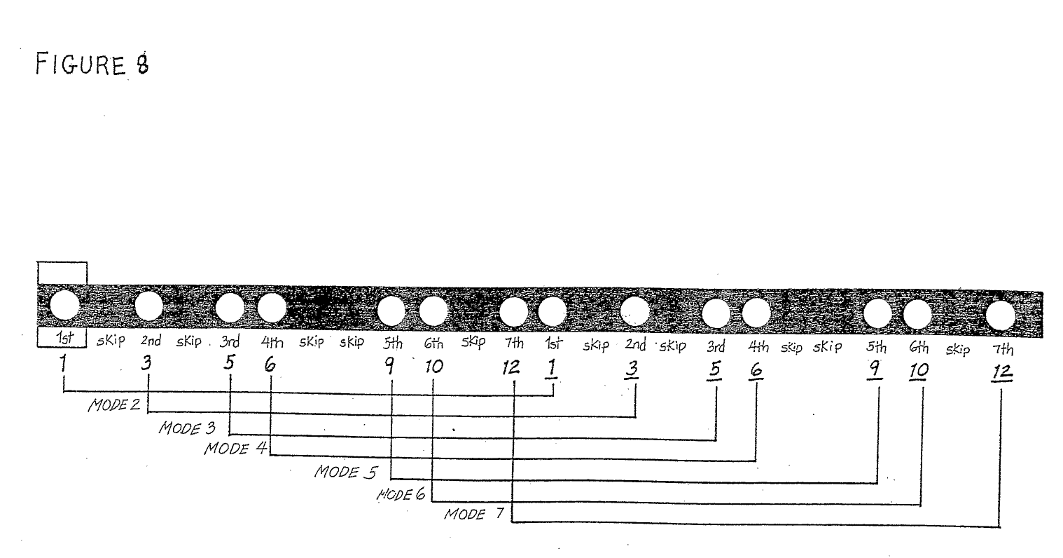

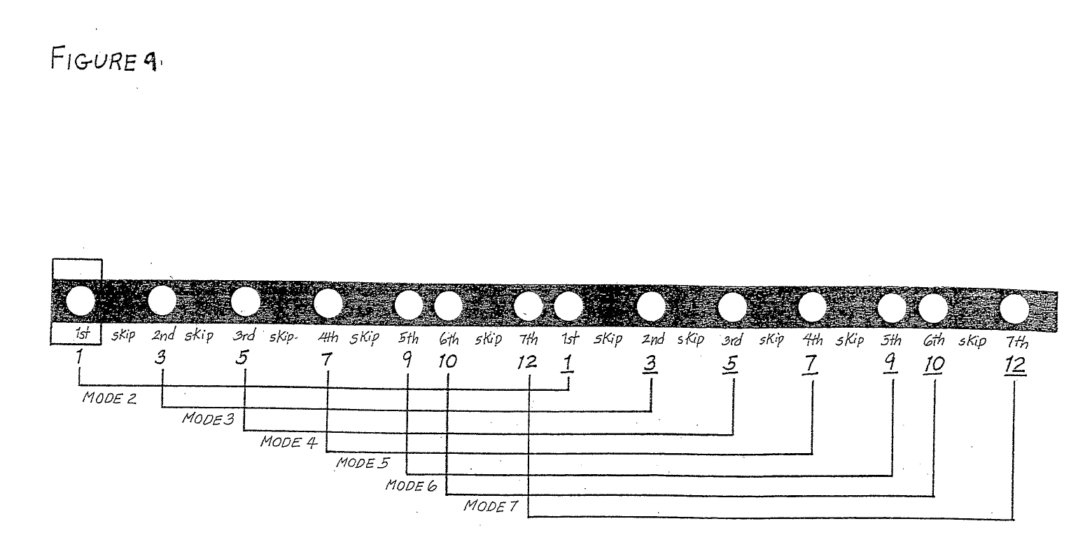

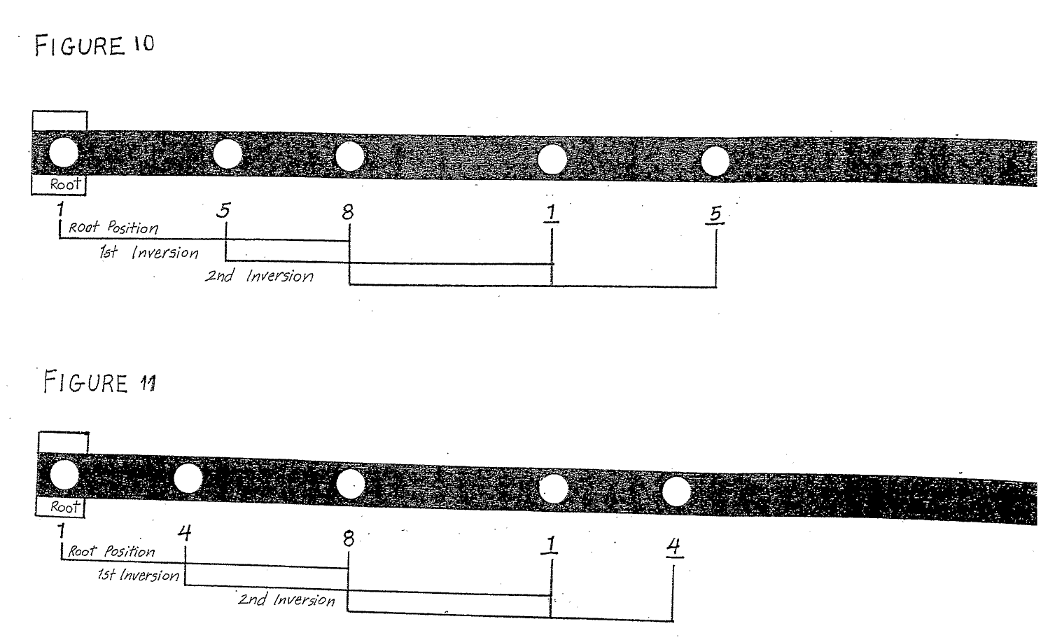

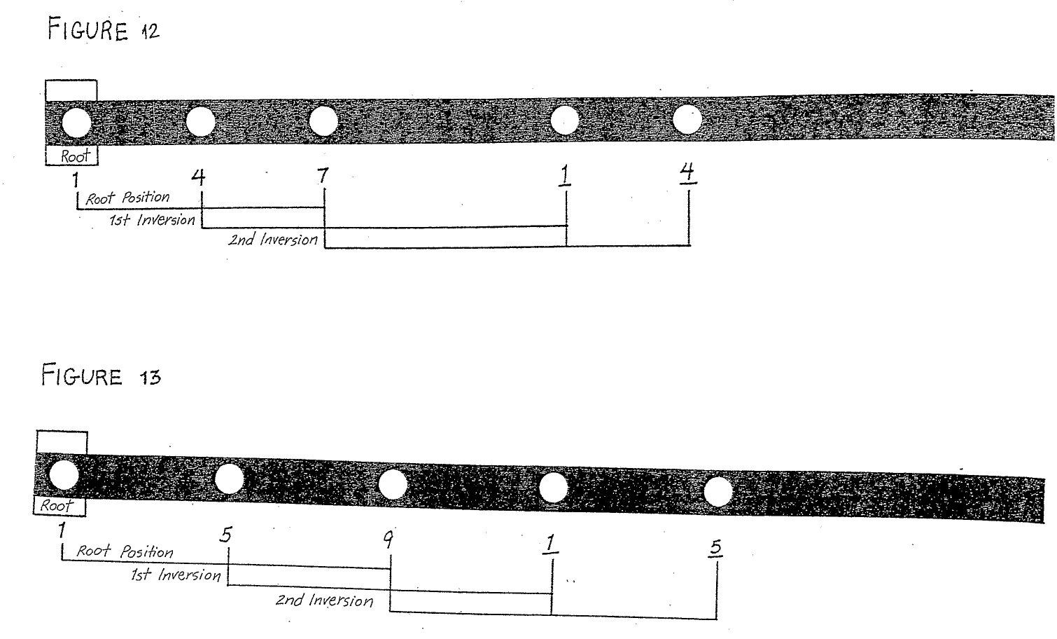

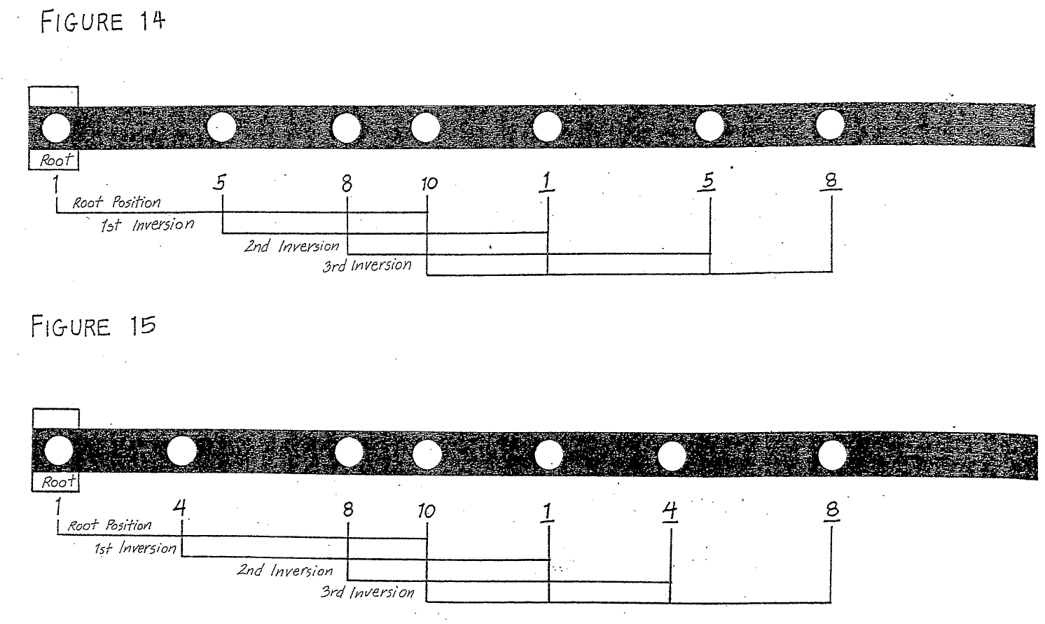

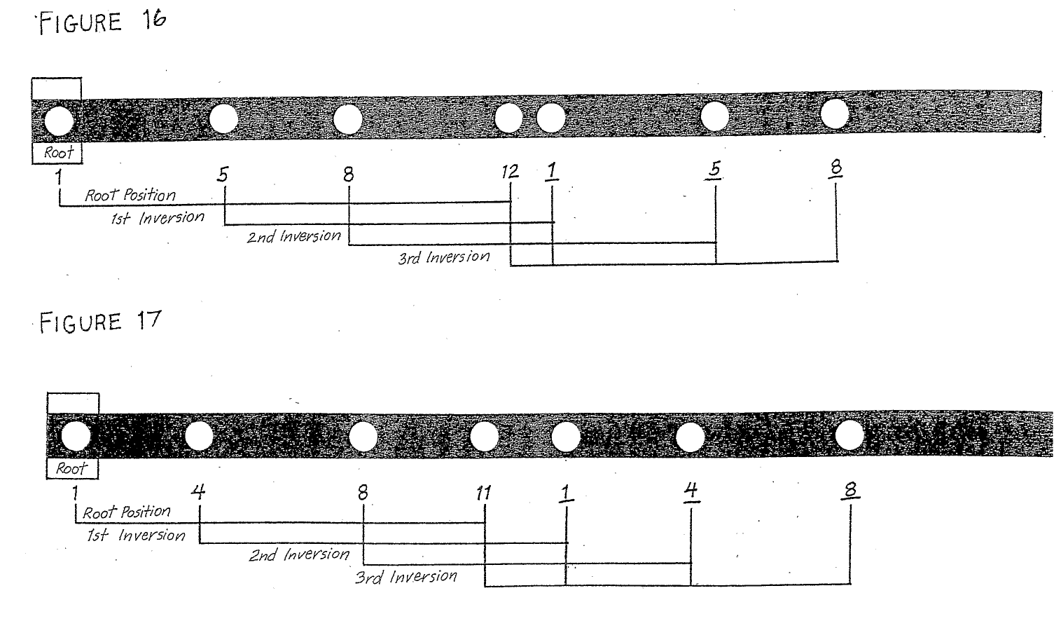

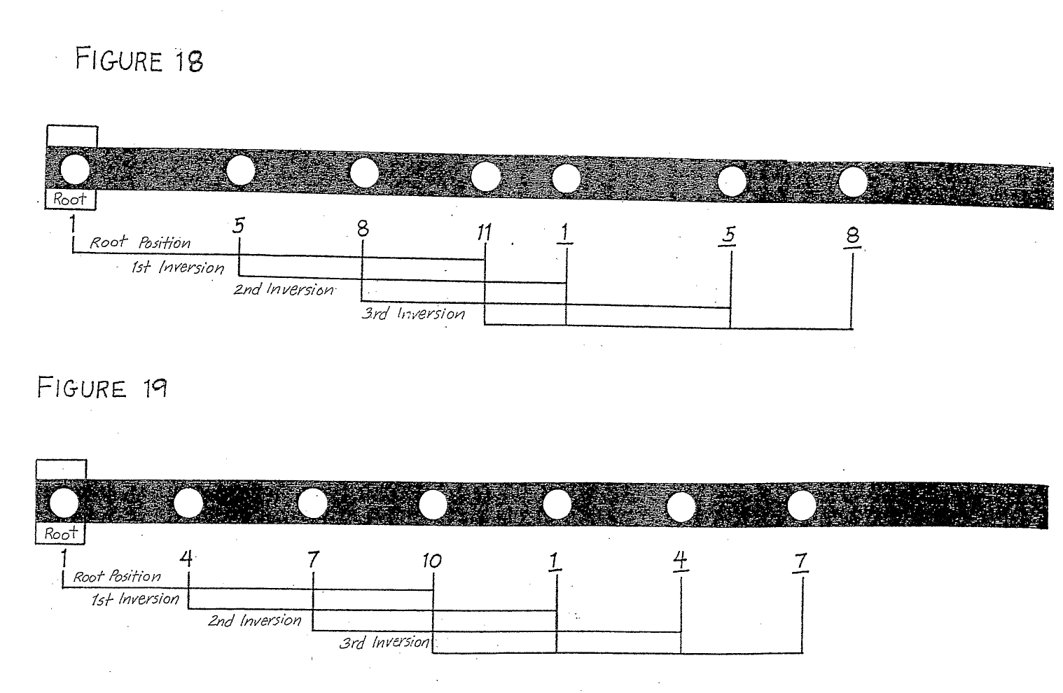

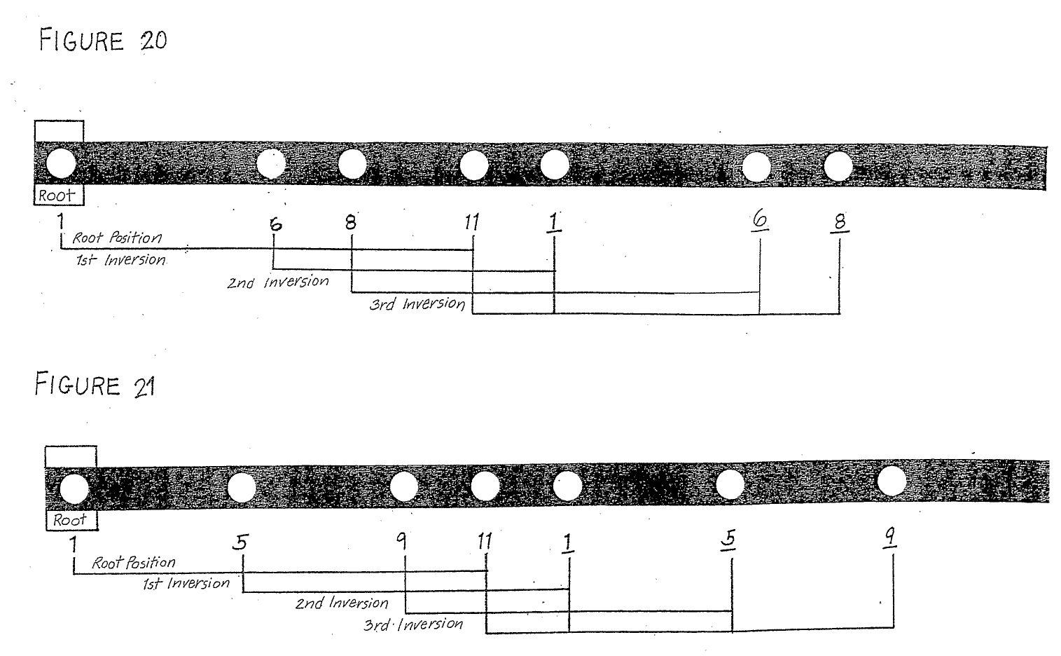

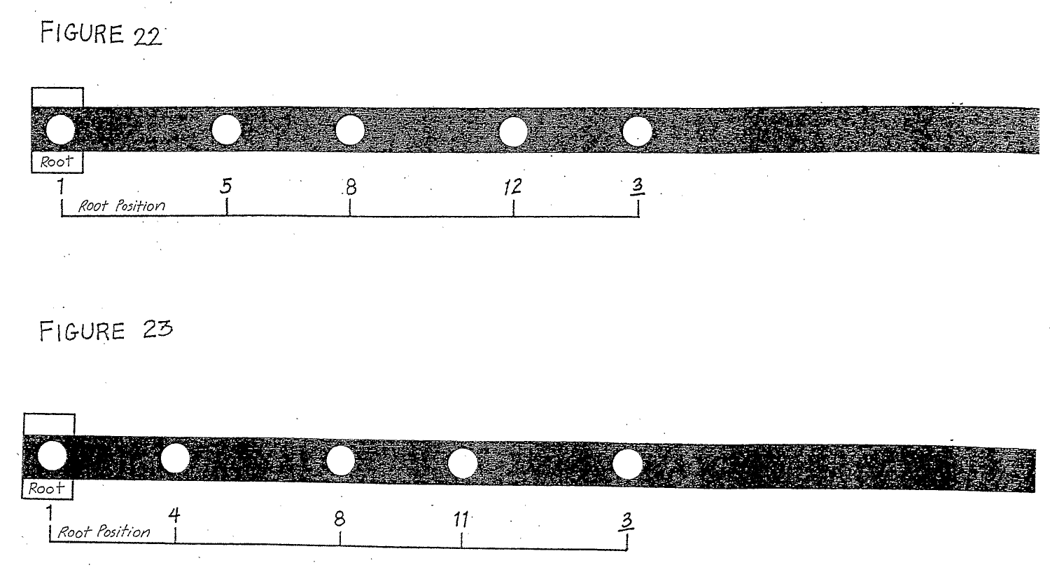

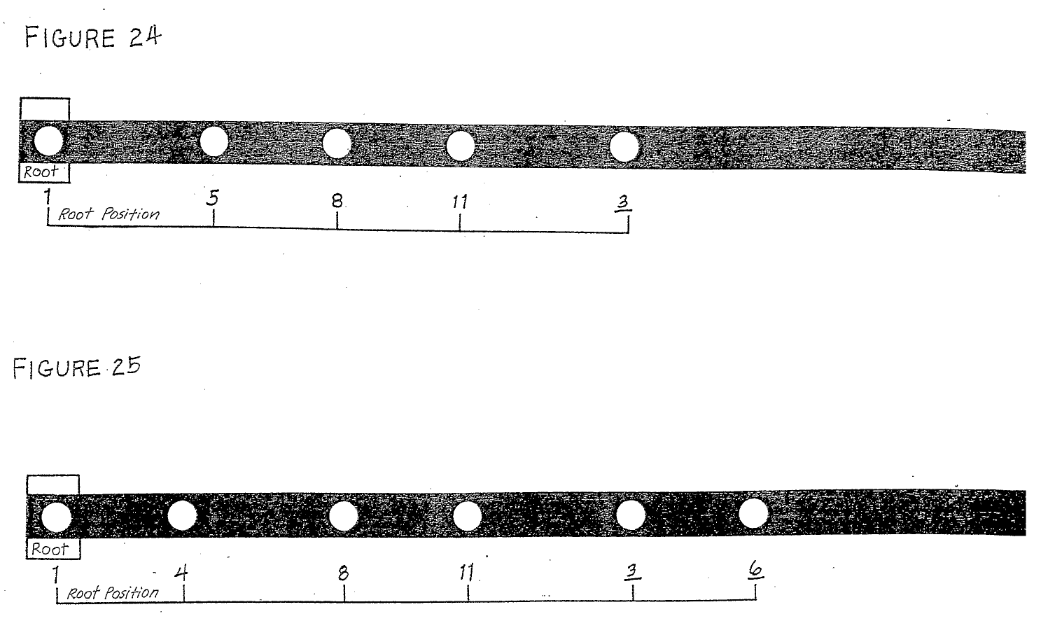

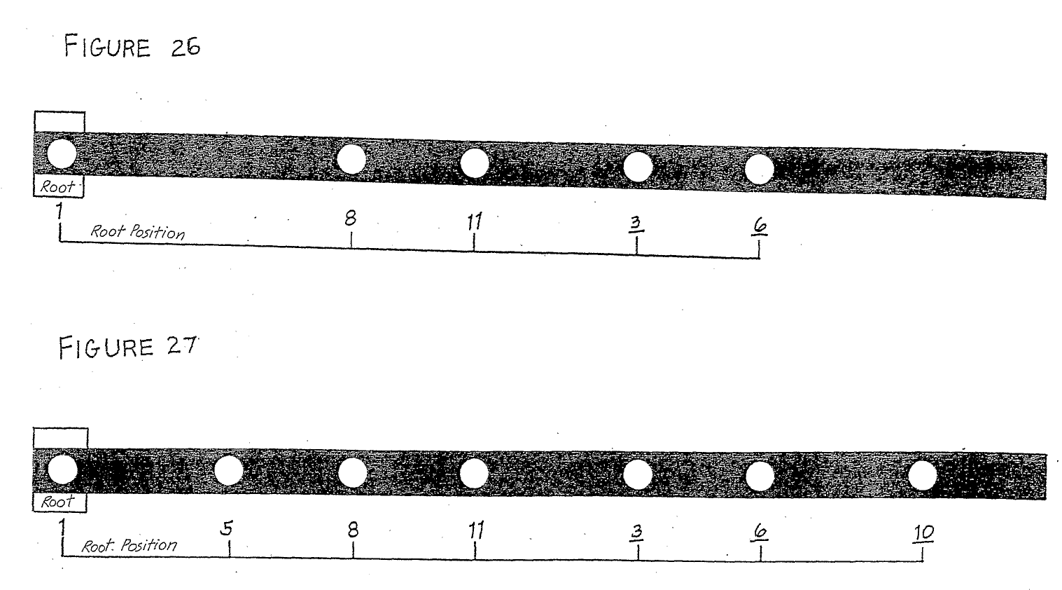

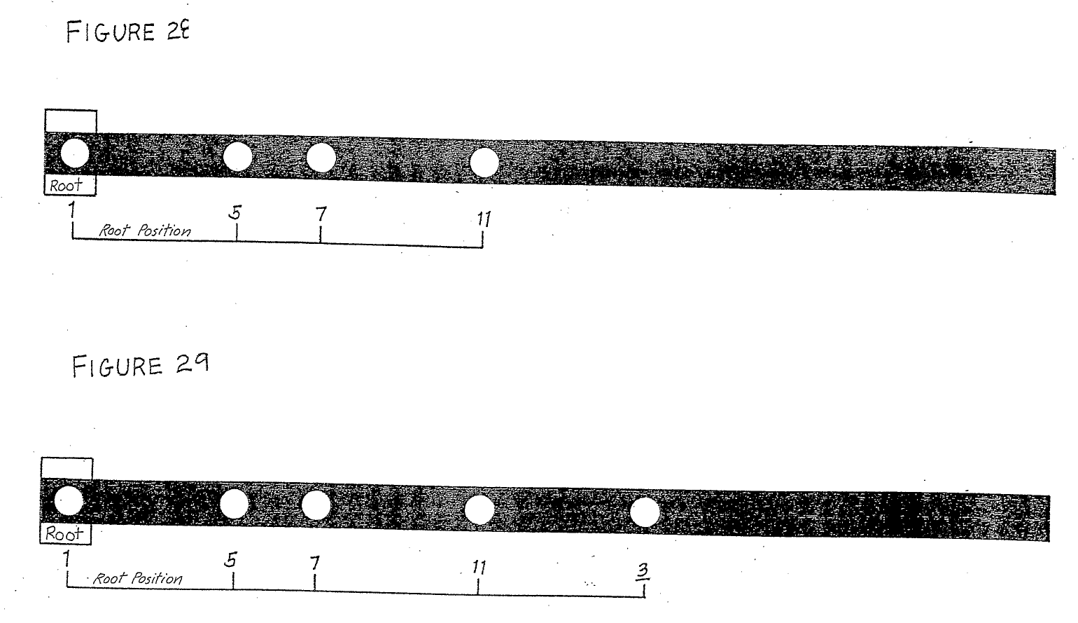

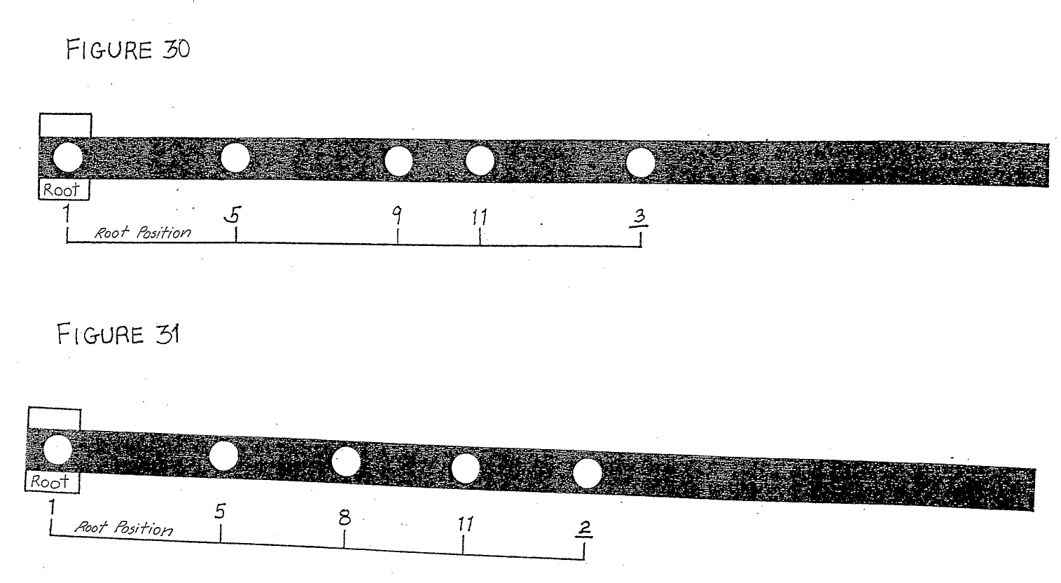

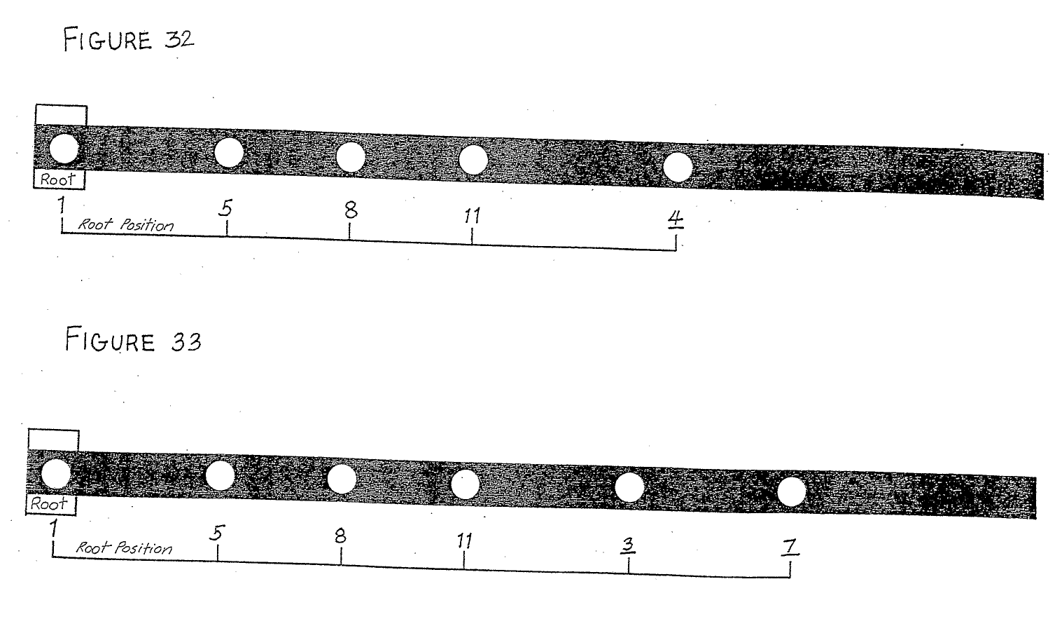

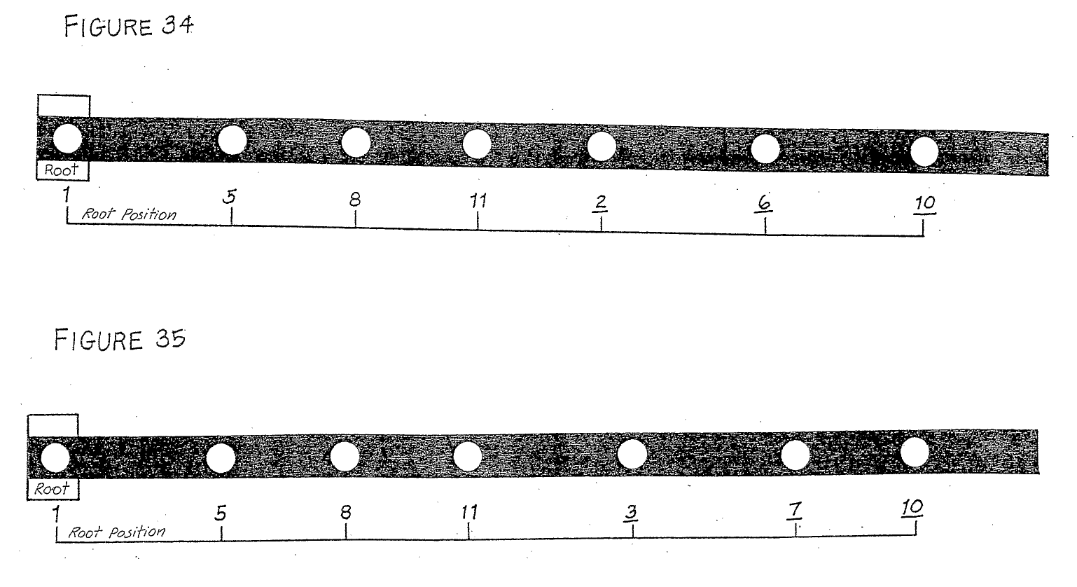

Cheock Decoder On the other hand, the following figures illustrate each Component of the Cheock Decoder that can be used to identify the corresponding musical elements, when positioned over the Music Code Notes and Chords Charts:

| | | | Applicable |
|---|---|---|---|
| Figure | | | Music Code |
| No. | Component | Musical Element Identified | Chart |
| 4 | Component 1 | 7 Major Chord Family Members in all 12 Keys | Chords Chart |
| 5 | Component 2 | 7 Minor Chord Family Members in all 12 Keys | Chords Chart |
| 6 | Component 3 | Major Scales and the 7 Modes | Notes Chart |
| 7 | Component 4 | Relative Minor Scales and the 7 Modes | Notes Chart |
| 8 | Component 5 | Harmonic Minor Scales and the 7 Modes | Notes Chart |
| 9 | Component 6 | Melodic Minor Scales and the 7 Modes | Notes Chart |
| 10 | Component 7 | Basic Chord Quality of 12 Major Chords in | Notes Chart |
| | | their Root Position and Inversions | |
| 11 | Component 8 | Basic Chord Quality of 12 Minor | Notes Chart |
| | | Chords in their Root Position and Inversions | |
| 12 | Component 9 | Basic Chord Quality of 12 Diminished Chords | Notes Chart |
| | | in their Root Position and Inversions | |
| 13 | Component 10 | Basic Chord Quality of 12 Augmented Chords | Notes Chart |
| | | in their Root Position and Inversions | |
| 14 | Component 11 | Basic Chord Quality of 12 Major 6^{th} Chords in | Notes Chart |
| | | their Root Position and Inversions | |
| 15 | Component 12 | Basic Chord Quality of 12 Minor 6^{th} Chords in | Notes Chart |
| | | their Root Position and Inversions | |
| 16 | Component 13 | Basic Chord Quality of 12 Major 7^{th} Chords in | Notes Chart |
| | | their Root Position and Inversions | |
| 17 | Component 14 | Basic Chord Quality of 12 Minor 7^{th} Chords in | Notes Chart |
| | | their Root Position and Inversions | |
| 18 | Component 15 | Basic Chord Quality of 12 7^{th} Chords in their | Notes Chart |
| | | Root Position and Inversions | |
| 19 | Component 16 | Basic Chord Quality of 12 Diminished 7^{th} | Notes Chart |
| | | Chords in their Root Position and Inversions | |
| 20 | Component 17 | Basic Chord Quality of 12 7^{th} Suspended 4^{th} | Notes Chart |
| | | Chords in their Root Position and Inversions | |
| 21 | Component 18 | Basic Chord Quality of 12 7^{th} Sharp 5 Chords | Notes Chart |
| | | in their Root Position and Inversions | |
| 22 | Component 19 | Expanded Chord Quality of 12 Major 9^{th} | Notes Chart |
| | | Chords in their Root Position | |
| 23 | Component 20 | Expanded Chord Quality of 12 Minor 9^{th} | Notes Chart |
| | | Chords in their Root Position | |
| 24 | Component 21 | Expanded Chord Quality of 12 9^{th} Chords in | Notes Chart |
| | | their Root Position | |
| 25 | Component 22 | Expanded Chord Quality of 12 Minor 11^{th} | Notes Chart |
| | | Chords in their Root Position | |
| 26 | Component 23 | Expanded Chord Quality of 12 11^{th} Chords in | Notes Chart |
| | | their Root Position | |
| 27 | Component 24 | Expanded Chord Quality of 12 13^{th} Chords in | Notes Chart |
| | | their Root Position | |
| 28 | Component 25 | Altered Chord Quality of 12 7^{th} Flat 5 Chords | Notes Chart |
| | | in their Root Position | |
| 29 | Component 26 | Altered Chord Quality of 12 9^{th} Flat 5 Chords | Notes Chart |
| | | in their Root Position | |
| 30 | Component 27 | Altered Chord Quality of 12 9^{th} Sharp 5 | Notes Chart |
| | | Chords in their Root Position | |
| 31 | Component 28 | Altered Chord Quality of 12 7^{th} Flat 9 Chords | Notes Chart |
| | | in their Root Position | |
| 32 | Component 29 | Altered Chord Quality of 12 7^{th} Sharp 9 | Notes Chart |
| | | Chords in their Root Position | |
| 33 | Component 30 | Altered Chord Quality of 12 9^{th} Sharp 11 | Notes Chart |
| | | Chords in their Root Position | |
| 34 | Component 31 | Altered Chord Quality of 12 13^{th} Flat 9 Chords | Notes Chart |
| | | in their Root Position | |
| 35 | Component 32 | Altered Chord Quality of 12 13^{th} Sharp 11 | Notes Chart |
| | | Chords in their Root Position | |

### BEST MODE FOR CARRYING OUT THE INVENTION

The graphic and visual presentation of the Music Code may be in the form of maps and charts, as illustrated in the drawings.

Variations in the visual presentation of the Music Code are acceptable for as long as the pattern reflected therein are preserved. The Music Code may be arranged in a horizontal, vertical or diagonal formation. The Keys may be ordered in ascending or descending pitch.

The Cheock Decoder may also be printed on a clear acetate overlay to scale with the corresponding Music Code.

The Invention may also be used in music software applications for composition and arrangement, transpositions, transitions.

### INDUSTRIAL APPLICABILITY

The Invention serves as a musical outline to simplify musical movements from key to key, chord to chord, note to note, and melody to melody. The Invention likewise reveals the patterns of compositions in music, whether it be classical, jazz, blues, rock, or contemporary music. Furthermore, the Invention is universally applicable to almost all types of instruments, including guitar, keyboards, piano, and xylophone.

With the Invention, musicians can easily identify sequential modulation patterns such that various compositions, including classical compositions of Beethoven and Mozart, can be easily identified and transposed in different keys using the same modulation patterns.

Moreover, the Invention opens novel musical pathways that have never been explored before, including musical compositions composed exclusively of tension chords or compositions with multiple key signatures.

In addition, the Invention unveils the Chord Derivation and Structure of every Chord Quality. It reveals musical pathways for melodies that have been composed and those that are yet to be composed. It also provides novel methods to learn music resulting in ease of memorization and speed of practical musical application. The Invention is based on numerical codes which can be adopted to provide significant-music software applications.

Finally, when the different components of the Cheock Decoder are applied over the Music Code Chords Chart (Components 1 and 2) and the Music Code Notes Charts (Components 3 to 32), the users thereof can, depending on which Component is utilized, effortlessly discern and identify Member Chord Families, Commonly Used Scales, Basic Chord Qualities, Expanded Chord Qualities, and Altered Chord Qualities.

1. The Numbers Chart, composed in a manner such that the numbers 1 to 12 are sequentially arranged in a horizontal manner, starting on the bottom row. The first row of numbers 1 to 12 is positioned at the bottom row and may be repeated horizontally in as many sets of 12 as desired. The second row of numbers 1 to 12 is arranged above the first row, with one step to the right, such that number 1 in the second row is located right above number 2 of the first row, number 2 in the second row is located right above number 3 of the first row and so on.
To complete a single usable numbers chart, the numbers 1 to 12 are made to repeat continuously to fill a tile that contains a complete set of 12 numbers, with number 1 of the next top row always above number 2 of the row right below it, number 2 of the top row located above number 3 of the bottom row, and so forth. This tile may then be repeated horizontally and vertically to produce a chart representing several sets of numbers from 1 to 12.

2. The Notes Chart, which uses the 12 Numerals in the Numbers Chart to represent the Chromatic 12 Musical Notes, in each of the 12 Keys,
Using the Numbers Chart as a blueprint, the series of number. 1's starting from the lower-left hand corner of the chart and moving diagonally upwards each represent the 12 different musical Keys from the key of C to the key of B. Thus, each of the 12 Keys are identified by the 12 number 1's.
Each Key is, in turn, composed of the Chromatic 12 Notes.
Correspondingly, the first note of each of the 12 Keys, as depicted in the Notes Chart, are likewise represented by the number 1's in the Numbers Chart. Hence, the first note in the Key of C, which is Note C, is in the number 1 location on the Numbers Chart located at the lower-left hand corner of the chart. Moving a step upwards in a diagonal manner, the first note in the Key of C#, which is Note C#, is also in the number 1 location on the Numbers Chart; and so on. In other words, each of the first notes of the 12 Keys are also identified by the 12 number 1's.
Corollary to the foregoing, the numbers 1 to 12 in each of the Keys (each row of numbers 1 to 12) represent each of the Chromatic 12 Notes as may be played in each Key. Hence, in the Key of C (the lowest row), the numbers 1 to 12 represent the Chromatic Notes C to B. In the Key of C# (one diagonal row above the Key of C), the numbers 1 to 12 represent the Chromatic Notes C# to C. In Key of B, the 12^{th} row of numbers 1 to 12 from the bottom, the numbers 1 to 12 represent the Chromatic Notes B to A#.
The relationship of the Chromatic 12 Notes and 12 Keys as derived from the Numbers Chart are illustrated in the Notes Chart. As a result, the numbers 1 to 12 found in the Numbers Chart are replaced with symbols for the corresponding Chromatic Notes and Keys.
As in the Numbers Chart, the Notes and Keys are made to repeat its pattern in a continuous sequence to fill a tile that contains a complete set of Notes and Keys. This tile may then be repeated horizontally and vertically to produce the Notes Chart representing a systemic visual repetition of several sets of Notes and Keys.

3. The Chords Chart, composed of the 12 Members of the Chord Family, which are the accepted 7 Members of the Chord Family and 5 additional Members of the Chord Family called “Super Tension Chords” by the Inventor.
The 12 Members of the Chord Family are as follows: 1M, 6M/2, 2m, 7M/4, 3m, 4M′ 2M/7, 5M, 3M/9, 6m, 6#M, 7=5M/12. Slash Chords represent inversions from Root position. The numbers below the slash represent the notes from the key of the applicable Chord Family, as reflected in the Notes Chart. To increase the use of the last chord (7^{th}) in the musical compositions, the inventor standardized the same to be 5M/12 when used within the Chord Family.
With the Chord Family expanded to 12 members by the Inventor, the numbers 1 to 12 in the Numbers Chart shall now be used to represent the 12 Members of the Chord Family, in each of the 12 Keys.
Again, using the Numbers Chart as a blueprint, and starting on the lower left corner of the chart, the series of lumber 1's moving diagonally upwards each represents the 12 Keys: from the Key of C to Key of B. Thus, the 12 Keys are represented by the 12 number 1's in the Numbers Chart, starting from the lower left corer moving diagonally up the chart.
Each Key is, in turn, composed of the 12 Members of the Chord Family.
Similar to the Notes Chart, the first Chord Member of each Key is also represented by the number 1. Hence, the first Chord Member (Chord C) in the Key of C is represented by the number 1 located in the lower left corner of the Numbers Chart. The first Chord Member (Chord C#) in the Key of Ci is also represented by the number 1 located diagonally above the first number 1; and so on. Thus, each of the first Chord Members in each of the Keys are also represented by the 12 number 1's.
On the other hand, the numbers 1 to 12 in each horizontal row of each Key, represents the 12 Members of the Chord Family as may be played in each Key. To illustrate, the 12 Members of the Chord Family in Key of C is represented by the numbers 1 to 12 in the lowest row in the Numbers Chart starting from Chord C (number 1) to Chord G/B (number 12). If a musician wishes to use the Chords in the Key of F, instead of the Key of C, then the Chords Chart will reveal that the Key of F begins in the 6^{th} number 1 position counting from the lower left hand corner of the Chart, and the Chords in the Key of F would be found in the same row, with Chord F (number 1) as the first chord, followed by Chords D/G^{b}, Gₘ, E/A^{b}, and so on until Chord C/E (number 12).
The relationship of the 12 Members of the Chord Family and 12 Keys as derived from the Numbers Chart are illustrated in the Chords Chart. As a result, the numbers 1 to 12 found in the Numbers Chart are replaced with symbols for the corresponding 12 Members of the Chords Family.
As in the Numbers Chart, the Chords and Keys are made to repeat its pattern in a continuous sequence to fill a tile that contains a complete set of Chords and Keys. This tile may then be repeated horizontally and vertically to produce the Chords Chart representing a systemic visual repetition of several sets of Chords and Keys.

4. Super Tension Chords as described in claim 3. The Super Tension Chords are composed of the following Chords: 6M/2, 7M/4, 2M/7, 3M/9, 6#M within their respective Chord Family.

5. The Music Code embodied in, and composed of, three (3) charts (the numbers chart, the notes chart, and the chords chart), as described in claims 1, 2, and 3. The notes chart and chords chart are direct musical derivations of the numbers chart.

6. The method of using the Music Code called the Cheock Decoder, composed of thirty two (32) specially designed visual components (the “Components”). Each Component consists of a horizontal bar with one or two sets of 12 fixed positions numbered 1 to 12 and with a distinct pattern of transparent circular gaps or openings.
More specifically, each Component, used in conjunction with the Music Code Notes and Chords Charts, can be used to identify the following musical elements:

| | | | Applicable |
|---|---|---|---|
| Figure | | | Music Code |
| No. | Component | Musical Element Identified | Chart |
| 1 | Component 1 | 7 Major Chord Family Members in all 12 Keys | Chords Chart |
| 2 | Component 2 | 7 Minor Chord Family Members in all 12 | Chords Chart |
| | | Keys | |
| 3 | Component 3 | Major Scales and the 7 Modes | Notes Chart |
| 4 | Component 4 | Relative Minor Scales and the 7 Modes | Notes Chart |
| 5 | Component 5 | Harmonic Minor Scales and the 7 Modes | Notes Chart |
| 6 | Component 6 | Melodic Minor Scales and the 7 Modes | Notes Chart |
| 7 | Component 7 | Basic Chord Quality of 12 Major Chords in | Notes Chart |
| | | their Root Position and Inversions | |
| 8 | Component 8 | Basic Chord Quality of 12 Minor Chords in | Notes Chart |
| | | their Root Position and Inversions | |
| 9 | Component 9 | Basic Chord Quality of 12 Diminished | Notes Chart |
| | | Chords in their Root Position and Inversions | |
| 10 | Component 10 | Basic Chord Quality of 12 Augmented | Notes Chart |
| | | Chords in their Root Position and Inversions | |
| 11 | Component 11 | Basic Chord Quality of 12 Major 6^{th} Chords | Notes Chart |
| | | in their Root Position and Inversions | |
| 12 | Component 12 | Basic Chord Quality of 12 Minor 6^{th} Chords | Notes Chart |
| | | in their Root Position and Inversions | |
| 13 | Component 13 | Basic Chord Quality of 12 Major 7^{th} Chords | Notes Chart |
| | | in their Root Position and Inversions | |
| 14 | Component 14 | Basic Chord Quality of 12 Minor 7^{th} Chords | Notes Chart |
| | | in their Root Position and Inversions | |
| 15 | Component 15 | Basic Chord Quality of 12 7^{th} Chords in their | Notes Chart |
| | | Root Position and Inversions | |
| 16 | Component 16 | Basic Chord Quality of 12 Diminished 7^{th} | Notes Chart |
| | | Chords in their Root Position and Inversions | |
| 17 | Component 17 | Basic Chord Quality of 12 7^{th} Suspended 4^{th} | Notes Chart |
| | | Chords in their Root Position and Inversions | |
| 18 | Component 18 | Basic Chord Quality of 12 7^{th} Sharp 5 | Notes Chart |
| | | Chords in their Root Position and Inversions | |
| 19 | Component 19 | Expanded Chord Quality of 12 Major 9^{th} | Notes Chart |
| | | Chords in their Root Position | |
| 20 | Component 20 | Expanded Chord Quality of 12 Minor 9^{th} | Notes Chart |
| | | Chords in their Root Position | |
| 21 | Component 21 | Expanded Chord Quality of 12 9^{th} Chords in | Notes Chart |
| | | their Root Position | |
| 22 | Component 22 | Expanded Chord Quality of 12 Minor 11^{th} | Notes Chart |
| | | Chords in their Root Position | |
| 23 | Component 23 | Expanded Chord Quality of 12 11^{th} Chords | Notes Chart |
| | | in their Root Position | |
| 24 | Component 24 | Expanded Chord Quality of 12 13^{th} Chords | Notes Chart |
| | | in their Root Position | |
| 25 | Component 25 | Altered Chord Quality of 12 7^{th} Flat 5 | Notes Chart |
| | | Chords in their Root Position | |
| 26 | Component 26 | Altered Chord Quality of 12 9^{th} Flat 5 | Notes Chart |
| | | Chords in their Root Position | |
| 27 | Component 27 | Altered Chord Quality of 12 9^{th} Sharp 5 | Notes Chart |
| | | Chords in their Root Position | |
| 28 | Component 28 | Altered Chord Quality of 12 7^{th} Flat 9 | Notes Chart |
| | | Chords in their Root Position | |
| 29 | Component 29 | Altered Chord Quality of 12 7^{th} Sharp 9 | Notes Chart |
| | | Chords in their Root Position | |
| 30 | Component 30 | Altered Chord Quality of 12 9^{th} Sharp 11 | Notes Chart |
| | | Chords in their Root Position | |
| 31 | Component 31 | Altered Chord Quality of 12 13^{th} Flat 9 | Notes Chart |
| | | Chords in their Root Position | |
| 32 | Component 32 | Altered Chord Quality of 12 13^{th} Sharp 11 | Notes Chart |
| | | Chords in their Root Position | |

Component 1 and 2
Component 1 and 2 are composed of a horizontal bar containing twelve (12) fixed positions with seven (7) transparent circular gaps or openings in the following positions:

| | |
|---|---|
| Component 1 | 1, 3, 5, 6, 8, 10 and 12 |
| Component 2 | 1, 3, 4, 6, 8, 9, and 11 |

Each gap is correspondingly identified with the proper ordinals (1^{st} to 7^{th}) and numerals, which are indicated directly below said gaps. The horizontal bar positions that do not contain gaps are appropriately labeled “SKIP” below said positions.
By aligning the left-most gap over the any of the twelve (12) key chords of the any chord family, as mapped in the Music Code Chord Chart, Component 1 and 2 will identify (a) the 7 Major Chord Family Members and the 7 Minor Chord Family Members, respectively, in all twelve (12) keys, (b) their sequential order within the Chord Family, and (c) the numerical code that uncovers them.
Component 3 to 6
Component 3 and 4 are composed of a continuous horizontal bar containing two (2) sets of twelve (12) fixed position. The positions are numbered one (1) to twelve (12) for the first set of 12 positions; and another series of numbers from one (1) to twelve (12) for the second set of 12 positions (higher octave). The horizontal bars contain seven (7) transparent circular gaps or openings in the following positions:

| | |
|---|---|
| Component 3 | 1, 3, 5, 6, 8, 10 and 12 |
| Component 4 | 1, 3, 4, 6, 8, 9, and 11 |
| Component 5 | 1, 3, 5, 6, 9, 10 and 12 |
| Component 6 | 1, 3, 5, 7, 9, 10 and 12 |

The gaps are identified with the proper ordinals (1^{st} to 7^{th}) and the corresponding numbers of its respective positions. To guide the user, the numerals for the second set of gaps are underlined, to indicate the higher octave. The horizontal bar positions that do not contain gaps are appropriately labeled “SKIP” below said positions.
By aligning the left-most gap over the key note of the musical scale to be uncovered in the Music Code, Component 3 to 6 will identify (a) the Major Scales, Relative Minor Scales, Harmonic Minor Scales, and Melodic Minor Scales, respectively, in all twelve (12) keys, (b) the sequential order of the Notes within the Scale, and (c) the numerical code that uncovers them.
In addition, the musical modes (pattern of intervals between each note in an octave) for each of the musical scales (major, relative minor, harmonic minor, and melodic minor scales) may be identified using Component 3 to 6 in conjunction with the Music Code Notes Chart. By using said Components, each of the modes in the applicable scale may be identified by the series of notes appearing in the gaps located in the positions as listed in the table below. Line indicators are also used in the Components to identify the gaps applicable to the different modes.

| | | | Positions in | Positions in |
|---|---|---|---|---|
| | Positions in | | Component 5 | Component 6 |
| | Component 3 | Positions in Component 4 | Harmonic Minor | Melodic Minor |
| | Major Scale | Relative Minor Scale | Scale | Scale |
| Mode 1 | 1, 3, 5, 6, 8, 10, 12, 1 | 1, 3, 4, 6, 8, 9, 11, 1 | 1, 3, 5, 6, 9, 10, 12, 1 | 1, 3, 5, 7, 9, 10, 12, 1 |
| Mode 2 | 3, 5, 6, 8, 10, 12, 1, 3 | 3, 4, 6, 8, 9, 11, 1, 3 | 3, 5, 6, 9, 10, 12, 1, 3 | 3, 5, 7, 9, 10, 12, 1, 3 |
| Mode 3 | 5, 6, 8, 10, 12, 1, 3, 5 | 4, 6, 8, 9, 11, 1, 3, 4 | 5, 6, 9, 10, 12, 1, 3, 5 | 5, 7, 9, 10, 12, 1, 3, 5 |
| Mode 4 | 6, 8, 10, 12, 1, 3, 5, 6 | 6, 8, 9, 11, 1, 3, 4, 6 | 6, 9, 10, 12, 1, 3, 5, 6 | 7, 9, 10, 12, 1, 3, 5, 7 |
| Mode 5 | 8, 10, 12, 1, 3, 5, 6, 8 | 8, 9, 11, 1, 3, 4, 6, 8 | 9, 10, 12, 1, 3, 5, 6, 9 | 9, 10, 12, 1, 3, 5, 7, 9 |
| Mode 6 | 10, 12, 1, 3, 5, 6, 8, 10 | 9, 11, 1, 3, 4, 6, 8, 9 | 10, 12, 1, 3, 5, 6, 9, 10 | 10, 12, 1, 3, 5, 7, 9, 10 |
| Mode 7 | 12, 1, 3, 5, 6, 8, 10, 12 | 11, 1, 3, 4, 6, 8, 9, 11 | 12, 1, 3, 5, 6, 9, 10, 12 | 12, 1, 3, 5, 7, 9, 10, 12 |

Component 7 to 32
Component 7 to 32 are used to identify the twenty-six (26) different musical chords in their root positions and inversions, as appearing the Music Code Notes Chart (see table on pages 23-24 hereof).
The Components are composed of a continuous horizontal bar containing two (2) sets of twelve (12) fixed position. The positions are numbered one (1) to twelve (12) for the first set of 12 positions; and another series of numbers from one (1) to twelve (12) for the second set of 12 positions (higher octave). The horizontal bar of each component contains between five (5) to seven (7) transparent circular gaps or openings in the following positions:

| | |
|---|---|
| Component 7 | 1, 5, 8, 1, 5 |
| Component 8 | 1, 4, 8, 1, 4 |
| Component 9 | 1, 4, 7, 1, 4 |
| Component 10 | 1, 5, 9, 1, 5 |
| Component 11 | 1, 5, 8, 10, 1, 5, 8 |
| Component 12 | 1, 4, 8, 10, 1, 4, 8 |
| Component 13 | 1, 5, 8, 12, 1, 5, 8 |
| Component 14 | 1, 4, 8, 11, 1, 4, 8 |
| Component 15 | 1, 5, 8, 11, 1, 5, 8 |
| Component 16 | 1, 4, 7, 10, 1, 4, 7 |
| Component 17 | 1, 6, 8, 11, 1, 6, 8 |
| Component 18 | 1, 5, 9, 11, 1, 5, 9 |
| Component 19 | 1, 5, 8, 12, 3 |
| Component 20 | 1, 4, 8, 11, 3 |
| Component 21 | 1, 5, 8, 11, 3 |
| Component 22 | 1, 4, 8, 11, 3, 6 |
| Component 23 | 1, 8, 11, 3, 6 |
| Component 24 | 1, 5, 8, 11, 3, 6, 10 |
| Component 25 | 1, 5, 7, 11 |
| Component 26 | 1, 5, 7, 11, 3 |
| Component 27 | 1, 5, 9, 11, 3 |
| Component 28 | 1, 5, 8, 11, 2 |
| Component 29 | 1, 5, 8, 11, 4 |
| Component 30 | 1, 5, 8, 11, 3, 7 |
| Component 31 | 1, 5, 8, 11, 2, 6, 10 |
| Component 32 | 1, 5, 8, 11, 3, 7, 10 |

The gaps are identified with the corresponding numbers of its respective positions. To guide the user, the numerals for the second set of gaps are underlined, to indicate the higher octave.
By aligning the left-most gap over the root note of the Chord Quality, as mapped in the Music Code Notes Chart, Component 7 to 32 will identify (a) the twelve (12) various chords (as may be applicable for each Component; see table below) in their Root Position, 1^{st} Inversion, 2 Inversion, and (b) the numerical code that uncovers them.
The various chords in their Root Positions and Inversions are identified by the series of notes appearing in the gaps located in the positions as listed in the table below. Line indicators are also used in the Components to identify the gaps applicable to the root position and various inversions.

| | | Root | 1^{st} | 2^{nd} | 3^{rd} |
|---|---|---|---|---|---|
| Components | Chords | Position | Inversion | Inversion | Inversion |
| Component 7 | Major Chords | 1, 5, 8 | 5, 8, 1 | 8, 1, 5 | — |
| Component 8 | Minor Chords | 1, 4, 8 | 4, 8, 1 | 8, 1, 4 | — |
| Component 9 | Diminished Chords | 1, 4, 7 | 4, 7, 1 | 7, 1, 4 | |
| Component 10 | Augmented Chords | 1, 5, 9 | 5, 9, 1 | 9, 1, 5 | — |
| Component 11 | Major 6^{th} Chords | 1, 5, 8, 10 | 5, 8, 10, 1 | 8, 10, 1, 5 | 10, 1, 5, 8 |
| Component 12 | Minor 6^{th} Chords | 1, 4, 8, 10 | 4, 8, 10, 1 | 8, 10, 1, 4 | 10, 1, 4, 8 |
| Component 13 | Major 7^{th} Chords | 1, 5, 8, 12 | 5, 8, 12, 1 | 8, 12, 1, 5 | 12, 1, 5, 8 |
| Component 14 | Minor 7^{th} Chords | 1, 4, 8, 11 | 4, 8, 11, 1 | 8, 11, 1, 4 | 11, 1, 4, 8 |
| Component 15 | 7^{th} Chords | 1, 5, 8, 11 | 5, 8, 11, 1 | 8, 11, 1, 5 | 11, 1, 5, 8 |
| Component 16 | Diminished 7^{th} Chords | 1, 4, 7, 10 | 4, 7, 10, 1 | 7, 10, 1, 4 | 10, 1, 4, 7 |
| Component 17 | 7^{th} Suspended 4^{th} | 1, 6, 8, 11 | 6, 8, 11, 1 | 8, 11, 1, 6 | 11, 1, 6, 8 |
| | Chords | | | | |
| Component 18 | 7^{th} Sharps 5 Chords | 1, 5, 9, 11 | 5, 9, 11, 1 | 9, 11, 1, 5 | 11, 1, 5, 9 |
| Component 19 | Major 9^{th} Chords in | 1, 5, 8, 12, 3 | — | — | — |
| | their Root Position | | | | |
| Component 20 | Minor 9^{th} Chords in | 1, 4, 8, 11, 3 | — | — | — |
| | their Root Position | | | | |
| Component 21 | 9^{th} Chords in their Root | 1, 5, 8, 11, 3 | — | — | — |
| | Position | | | | |
| Component 22 | Minor 11^{th} Chords in | 1, 4, 8, 11, | — | — | — |
| | their Root Position | 3, 6 | | | |
| Component 23 | 11^{th} Chords in their | 1, 8, 11, 3, 6 | — | — | — |
| | Root Position | | | | |
| Component 24 | 13^{th} Chords in their | 1, 5, 8, 11, | — | — | — |
| | Root Position | 3, 6, 10 | | | |
| Component 25 | 7^{th} Flat 5 Chords in | 1, 5, 7, 11 | — | — | — |
| | their Root Position | | | | |
| Component 26 | 9^{th} Flat 5 Chords in | 1, 5, 7, 11, 3 | — | — | — |
| | their Root Position | | | | |
| Component 27 | 9^{th} Sharp 5 Chords in | 1, 5, 9, 11, 3 | — | — | — |
| | their Root Position | | | | |
| Component 28 | 7^{th} Flat 9 Chords in | 1, 5, 8, 11, 2 | — | — | — |
| | their Root Position | | | | |
| Component 29 | 7^{th} Sharp 9 Chords in | 1, 5, 8, 11, 4 | — | — | — |
| | their Root Position | | | | |
| Component 30 | 9^{th} Sharp 11 Chords in | 1, 5, 8, 11, | — | — | — |
| | their Root Position | 3, 7 | | | |
| Component 31 | 13^{th} Flat 9 Chords in | 1, 5, 8, 11, | — | — | — |
| | their Root Position | 2, 6, 10 | | | |
| Component 32 | 13^{th} Sharp 11 Chords in | 1, 5, 8, 11, | — | — | — |
| | their Root Position | 3, 7, 10 | | | |

7. Component 1 of claim 6

8. Component 2 of claim 6

9. Component 3 of claim 6

10. Component 4 of claim 6

11. Component 5 of claim 6

12. Component 6 of claim 6

13. Component 7 of claim 6

14. Component 8 of claim 6

15. Component 9 of claim 6

16. Component 10 of claim 6

17. Component 11 of claim 6

18. Component 12 of claim 6

19. Component 13 of claim 6

20. Component 14 of claim 6

21. Component 15 of claim 6

22. Component 16 of claim 6

23. Component 17 of claim 6

24. Component 18 of claim 6

25. Component 19 of claim 6

26. Component 20 of claim 6

27. Component 21 of claim 6

28. Component 22 of claim 6

29. Component 23 of claim 6

30. Component 24 of claim 6

31. Component 25 of claim 6

32. Component 26 of claim 6

33. Component 27 of claim 6

34. Component 28 of claim 6

35. Component 29 of claim 6

36. Component 30 of claim 6

37. Component 31 of claim 6

38. Component 32 of claim 6
